(19) United States
(12) Patent Application Publication
(10) Pub. No.: US 2025/0217662 A1
(43) Pub. Date: Jul. 3, 2025

(54) Model Level Update Skipping in Compressed Incremental Learning

(71) Applicant: Nokia Technologies Oy, Espoo (FI)

(72) Inventors: Hamed Rezazadegan Tavakoli, Espoo (FI); Francesco CRICRI, Tampere (FI); Honglei ZHANG, Tampere (FI); Emre Baris AKSU, Tampere (FI); Miska Matias HANNUKSELA, Tampere (FI)

(21) Appl. No.: 18/848,560

(22) PCT Filed: Apr. 11, 2023
(86) PCT No.: PCT/US2023/018114

§ 371 Date: Sep. 19, 2024

Related U.S. Application Data
(60) Provisional application No. 63/331,330, filed on Apr. 15, 2022.

(51) Int. Cl. G06N 3/096

(52) U.S. Cl. CPC G06N 3/096

(57) ABSTRACT

An apparatus including: at least one processor; and at least one memory storing instructions that, when executed by the at least one processor, cause the apparatus to: determine a first value of a first epoch of training a neural network based on a relation applied to at least one weight of the neural network from the first epoch and a base model; determine a second value of a second epoch of training the neural network based on the relation applied to the at least one weight of the neural network from the second epoch and the base model; wherein the second epoch occurs later than the first epoch; and determine whether to communicate a weight update to the at least one weight of the neural network between the second epoch of training and the first epoch of training, based at least on the first value and the second value.

### TECHNICAL FIELD

The examples and non-limiting embodiments relate generally to multimedia transport and machine learning and, more particularly, to model level update skipping in compressed incremental learning.

### BACKGROUND

It is known to perform data compression and decoding in a multimedia system.

### SUMMARY

In accordance with an aspect, an apparatus includes: at least one processor; and at least one memory storing instructions that, when executed by the at least one processor, cause the apparatus at least to: determine a first value of a first epoch of training a neural network based on a relation applied to at least one weight of the neural network from the first epoch and a base model; determine a second value of a second epoch of training the neural network based on the relation applied to the at least one weight of the neural network from the second epoch and the base model; wherein the second epoch occurs later than the first epoch; and determine whether to communicate a weight update to the at least one weight of the neural network between the second epoch of training and the first epoch of training, based at least on the first value and the second value.

In accordance with an aspect, an apparatus includes: at least one processor; and at least one memory storing instructions that, when executed by the at least one processor, cause the apparatus at least to: determine whether to communicate a weight update to at least one weight of a neural network between a second epoch of training the neural network and a first epoch of training the neural network; wherein the determination of whether to communicate the weight update between the second epoch of training and the first epoch of training is made at a model level independent of a tensor content or a validation scheme; and signal to a receiver with a one-bit indication a presence or absence of the weight update between the second epoch of training and the first epoch of training.

In accordance with an aspect, an apparatus includes: at least one processor; and at least one memory storing instructions when executed by the t least one processor, cause the apparatus at least to: receive signaling of a presence or absence of a weight update between a second epoch of training a neural network and a first epoch of training the neural network; wherein the signaling of the presence or absence of the weight update between the second epoch of training and the first epoch of training is received independent of a tensor content or a validation scheme; decode an identifier of a base model used to train the neural network, in response to the presence of the weight update between a second epoch of training a neural network and a first epoch of training the neural network; and decode a payload of a neural network data unit with applying the weight update to the base model, in response to decoding the identifier of the base model used to train the neural network.

In accordance with an aspect, a method includes: determining a first value of a first epoch of training a neural network based on a relation applied to at least one weight of the neural network from the first epoch and a base model; determining a second value of a second epoch of training the neural network based on the relation applied to the at least one weight of the neural network from the second epoch and the base model; wherein the second epoch occurs later than the first epoch; and determining whether to communicate a weight update to the at least one weight of the neural network between the second epoch of training and the first epoch of training, based at least on the first value and the second value.

In accordance with an aspect, a method includes: determining whether to communicate a weight update to at least one weight of a neural network between a second epoch of training the neural network and a first epoch of training the neural network; wherein the determination of whether to communicate the weight update between the second epoch of training and the first epoch of training is made at a model level independent of a tensor content or a validation scheme; and signaling to a receiver with a one-bit indication a presence or absence of the weight update between the second epoch of training and the first epoch of training.

In accordance with an aspect, a method includes: receiving signaling of a presence or absence of a weight update between a second epoch of training a neural network and a first epoch of training the neural network; wherein the signaling of the presence or absence of the weight update between the second epoch of training and the first epoch of training is received independent of a tensor content or a validation scheme; decoding an identifier of a base model used to train the neural network, in response to the presence of the weight update between a second epoch of training a neural network and a first epoch of training the neural network; and decoding a payload of a neural network data unit with applying the weight update to the base model, in response to decoding the identifier of the base model used to train the neural network.

In accordance with an aspect, an apparatus includes: means for determining a first value of a first epoch of training a neural network based on a relation applied to at least one weight of the neural network from the first epoch and a base model; means for determining a second value of a second epoch of training the neural network based on the relation applied to the at least one weight of the neural network from the second epoch and the base model; wherein the second epoch occurs later than the first epoch; and means for determining whether to communicate a weight update to the at least one weight of the neural network between the second epoch of training and the first epoch of training, based at least on the first value and the second value.

In accordance with an aspect, an apparatus includes: means for determining whether to communicate a weight update to at least one weight of a neural network between a second epoch of training the neural network and a first epoch of training the neural network; wherein the determination of whether to communicate the weight update between the second epoch of training and the first epoch of training is made at a model level independent of a tensor content or a validation scheme; and means for signaling to a receiver with a one-bit indication a presence or absence of the weight update between the second epoch of training and the first epoch of training.

In accordance with an aspect, an apparatus includes: means for receiving signaling of a presence or absence of a weight update between a second epoch of training a neural network and a first epoch of training the neural network; wherein the signaling of the presence or absence of the weight update between the second epoch of training and the first epoch of training is received independent of a tensor content or a validation scheme; means for decoding an identifier of a base model used to train the neural network, in response to the presence of the weight update between a second epoch of training a neural network and a first epoch of training the neural network; and means for decoding a payload of a neural network data unit with applying the weight update to the base model, in response to decoding the identifier of the base model used to train the neural network.

In accordance with an aspect, a non-transitory program storage device readable by a machine, tangibly embodying a program of instructions executable with the machine for performing operations is provided, the operations including: determining a first value of a first epoch of training a neural network based on a relation applied to at least one weight of the neural network from the first epoch and a base model; determining a second value of a second epoch of training the neural network based on the relation applied to the at least one weight of the neural network from the second epoch and the base model; wherein the second epoch occurs later than the first epoch; and determining whether to communicate a weight update to the at least one weight of the neural network between the second epoch of training and the first epoch of training, based at least on the first value and the second value.

In accordance with an aspect, a non-transitory program storage device readable by a machine, tangibly embodying a program of instructions executable with the machine for performing operations is provided, the operations including: determining whether to communicate a weight update to at least one weight of a neural network between a second epoch of training the neural network and a first epoch of training the neural network; wherein the determination of whether to communicate the weight update between the second epoch of training and the first epoch of training is made at a model level independent of a tensor content or a validation scheme; and signaling to a receiver with a one-bit indication a presence or absence of the weight update between the second epoch of training and the first epoch of training.

In accordance with an aspect, a non-transitory program storage device readable by a machine, tangibly embodying a program of instructions executable with the machine for performing operations is provided, the operations including: receiving signaling of a presence or absence of a weight update between a second epoch of training a neural network and a first epoch of training the neural network; wherein the signaling of the presence or absence of the weight update between the second epoch of training and the first epoch of training is received independent of a tensor content or a validation scheme; decoding an identifier of a base model used to train the neural network, in response to the presence of the weight update between a second epoch of training a neural network and a first epoch of training the neural network; and decoding a payload of a neural network data unit with applying the weight update to the base model, in response to decoding the identifier of the base model used to train the neural network.

### BRIEF DESCRIPTION OF THE DRAWINGS

The foregoing aspects and other features are explained in the following description, taken in connection with the accompanying drawings, wherein:

FIG. 1 shows schematically an electronic device employing embodiments of the examples described herein.

FIG. 2 shows schematically a user equipment suitable for employing embodiments of the examples described herein.

FIG. 3 further shows schematically electronic devices employing embodiments of the examples described herein connected using wireless and wired network connections.

FIG. 4 shows schematically a block chart of an encoder used for data compression on a general level.

FIG. 5 shows an example syntax that may be implemented as part of a model parameter set.

FIG. 6 shows another example syntax that may be implemented as part of a model parameter set.

FIG. 7 is an example apparatus configured to implement model level update skipping in compressed incremental learning, based on the examples described herein.

FIG. 8 is an example method to implement model level update skipping in compressed incremental learning, based on the examples described herein.

FIG. 9 is an example method to implement model level update skipping in compressed incremental learning, based on the examples described herein.

FIG. 10 is an example method to implement model level update skipping in compressed incremental learning, based on the examples described herein.

### DETAILED DESCRIPTION OF EXAMPLE EMBODIMENTS

Described herein is a practical approach to implement model level update skipping in compressed incremental learning. The models described herein may be used to perform any task, such as data compression, data decompression, video compression, video decompression, image or video object detection, classification, object classification, object tracking, speech recognition, language translation, music transcription, etc.

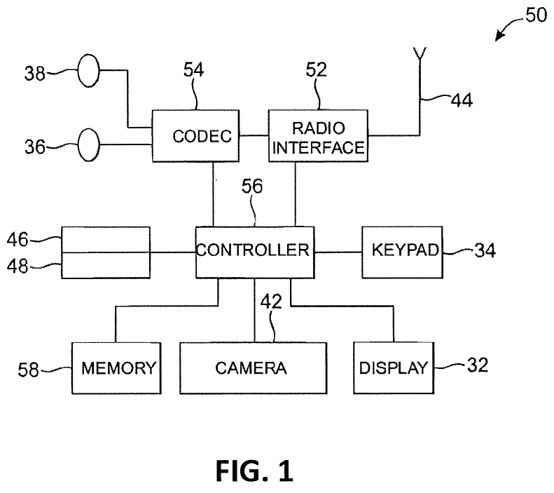

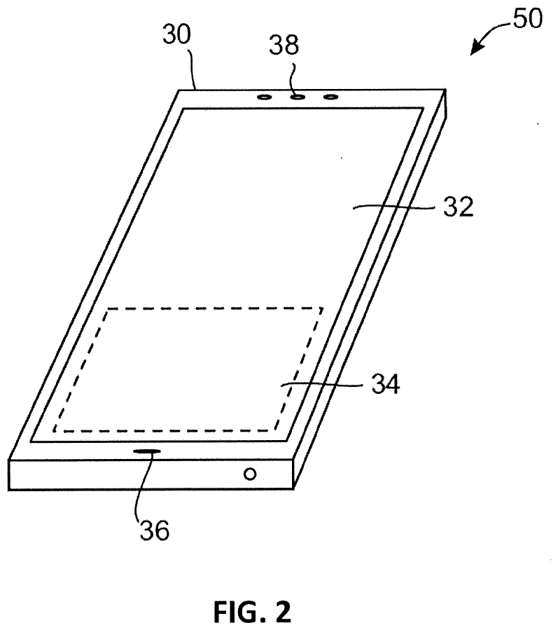

The following describes in detail a suitable apparatus and possible mechanisms to implement aspects of model level update skipping in compressed incremental learning. In this regard reference is first made to FIG. 1 and FIG. 2, where FIG. 1 shows an example block diagram of an apparatus 50. The apparatus may be an Internet of Things (IoT) apparatus configured to perform various functions, such as for example, gathering information by one or more sensors, receiving or transmitting information, analyzing information gathered or received by the apparatus, or the like. The apparatus may comprise a neural network weight update coding system, which may incorporate a codec. FIG. 2 shows a layout of an apparatus according to an example embodiment. The elements of FIG. 1 and FIG. 2 are explained next.

The electronic device 50 may for example be a mobile terminal or user equipment of a wireless communication system, a sensor device, a tag, or other lower power device. However, it would be appreciated that embodiments of the examples described herein may be implemented within any electronic device or apparatus which may process data by neural networks.

The apparatus 50 may comprise a housing 30 for incorporating and protecting the device. The apparatus 50 further may comprise a display 32 in the form of a liquid crystal display. In other embodiments of the examples described herein the display may be any suitable display technology suitable to display an image or video. The apparatus 50 may further comprise a keypad 34. In other embodiments of the examples described herein any suitable data or user interface mechanism may be employed. For example the user interface may be implemented as a virtual keyboard or data entry system as part of a touch-sensitive display.

The apparatus may comprise a microphone 36 or any suitable audio input which may be a digital or analog signal input. The apparatus 50 may further comprise an audio output device which in embodiments of the examples described herein may be any one of: an earpiece 38, speaker, or an analog audio or digital audio output connection. The apparatus 50 may also comprise a battery (or in other embodiments of the examples described herein the device may be powered by any suitable mobile energy device such as solar cell, fuel cell or clockwork generator). The apparatus may further comprise a camera capable of recording or capturing images and/or video. The apparatus 50 may further comprise an infrared port for short range line of sight communication to other devices. In other embodiments the apparatus 50 may further comprise any suitable short range communication solution such as for example a Bluetooth wireless connection or a USB/firewire wired connection.

The apparatus 50 may comprise a controller 56, processor or processor circuitry for controlling the apparatus 50. The controller 56 may be connected to memory 58 which in embodiments of the examples described herein may store both data in the form of image and audio data and/or may also store instructions for implementation on the controller 56. The controller 56 may further be connected to codec circuitry 54 suitable for carrying out coding/compression of neural network weight updates and/or decoding of audio and/or video data or assisting in coding and/or decoding carried out by the controller.

The apparatus 50 may further comprise a card reader 48 and a smart card 46, for example a UICC and UICC reader for providing user information and being suitable for providing authentication information for authentication and authorization of the user at a network.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) and/or for receiving radio frequency signals from other apparatus(es).

The apparatus 50 may comprise a camera capable of recording or detecting individual frames which are then passed to the codec 54 or the controller for processing. The apparatus may receive the video image data or machine learning data for processing from another device prior to transmission and/or storage. The apparatus 50 may also receive either wirelessly or by a wired connection the image for coding/decoding. The structural elements of apparatus 50 described above represent examples of means for performing a corresponding function.

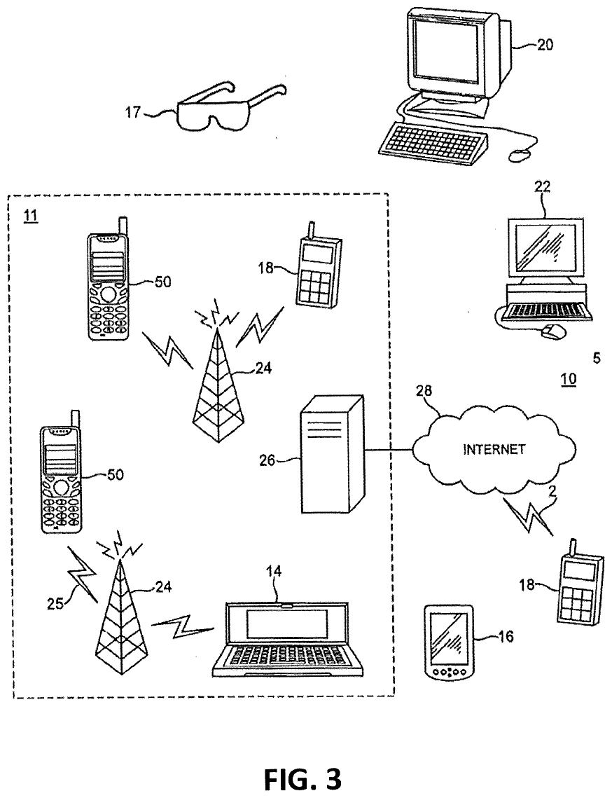

With respect to FIG. 3, an example of a system within which embodiments of the examples described herein can be utilized is shown. The system 10 comprises multiple communication devices which can communicate through one or more networks. The system 10 may comprise any combination of wired or wireless networks including, but not limited to a wireless cellular telephone network (such as a GSM, UMTS, CDMA, LTE, 4G, 5G network etc.), a wireless local area network (WLAN) such as defined by any of the IEEE 802.x standards, a Bluetooth personal area network, an Ethernet local area network, a token ring local area network, a wide area network, and the Internet.

The system 10 may include both wired and wireless communication devices and/or apparatus 50 suitable for implementing embodiments of the examples described herein.

For example, the system shown in FIG. 3 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport, or a head mounted display (HMD) 17.

The embodiments may also be implemented in a set-top box; i.e. a digital TV receiver, which may/may not have a display or wireless capabilities, in tablets or (laptop) personal computers (PC), which have hardware and/or software to process neural network data, in various operating systems, and in chipsets, processors, DSPs and/or embedded systems offering hardware/software based coding.

Some or further apparatus may send and receive calls and messages and communicate with service providers through a wireless connection 25 to a base station 24. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11, 3GPP Narrowband IoT and any similar wireless communication technology. A communications device involved in implementing various embodiments of the examples described herein may communicate using various media including, but not limited to, radio, infrared, laser, cable connections, and any suitable connection.

In telecommunications and data networks, a channel may refer either to a physical channel or to a logical channel. A physical channel may refer to a physical transmission medium such as a wire, whereas a logical channel may refer to a logical connection over a multiplexed medium, capable of conveying several logical channels. A channel may be used for conveying an information signal, for example a bitstream, from one or several senders (or transmitters) to one or several receivers.

The embodiments may also be implemented in so-called IoT devices. The Internet of Things (IoT) may be defined, for example, as an interconnection of uniquely identifiable embedded computing devices within the existing Internet infrastructure. The convergence of various technologies has and may enable many fields of embedded systems, such as wireless sensor networks, control systems, home/building automation, etc. to be included in the Internet of Things (IoT). In order to utilize the Internet IoT devices are provided with an IP address as a unique identifier. IoT devices may be provided with a radio transmitter, such as a WLAN or Bluetooth transmitter or a RFID tag. Alternatively, IoT devices may have access to an IP-based network via a wired network, such as an Ethernet-based network or a power-line connection (PLC).

One important application where model level update skipping in compressed incremental learning is important, is the use case of neural network based codecs, such as neural network based video codecs. Video codecs may use one or more neural networks. In a first case, the video codec may be a conventional video codec such as the Versatile Video Codec (VVC/H.266) that has been modified to include one or more neural networks. Examples of these neural networks are:
1. a neural network filter to be used as one of the in-loop filters of VVC
2. a neural network filter to replace one or more of the in-loop filter(s) of VVC
3. a neural network filter to be used as a post-processing filter
4. a neural network to be used for performing intra-frame prediction
5. a neural network to be used for performing inter-frame prediction.

In a second case, which is usually referred to as an end-to-end learned video codec, the video codec may comprise a neural network that transforms the input data into a more compressible representation. The new representation may be quantized, lossless compressed, then lossless decompressed, dequantized, and then another neural network may transform its input into reconstructed or decoded data.

In both of the above two cases, there may be one or more neural networks at the decoder-side, and consider the example of one neural network filter. The encoder may finetune the neural network filter by using the ground-truth data which is available at encoder side (the uncompressed data). Finetuning may be performed in order to improve the neural network filter when applied to the current input data, such as to one or more video frames. Finetuning may comprise running one or more optimization iterations on some or all the learnable weights of the network filter. An neural optimization iteration may comprise computing gradients of a loss function with respect to some or all the learnable weights of the neural network filter, for example by using the backpropagation algorithm, and then updating the some or all learnable weights by using an optimizer, such as the stochastic gradient descent optimizer. The loss function may comprise one or more loss terms. One example loss term may be the mean squared error (MSE). Other distortion metrics may be used as the loss terms. The loss function may be computed by providing one or more data to the input of the neural network filter, obtaining one or more corresponding outputs from the neural network filter, and computing a loss term by using the one or more outputs from the neural network filter and one or more ground-truth data. The difference between the weights of the finetuned neural network and the weights of the neural network before finetuning is referred to as the weight-update. This weight-update needs to be encoded, provided to the decoder side together with the encoded video data, and used at the decoder side for updating the neural network filter. The updated neural network filter is then used as part of the video decoding process or as part of the video post-processing process. It is desirable to encode the weight-update such that it requires a small number of bits. Thus, the examples described herein consider also this use case of neural network based codecs as a potential application of the compression of weight-updates.

In further description of the neural network based codec use case, an MPEG-2 transport stream (TS), specified in ISO/IEC 13818-1 or equivalently in ITU-T Recommendation H.222.0, is a format for carrying audio, video, and other media as well as program metadata or other metadata, in a multiplexed stream. A packet identifier (PID) is used to identify an elementary stream (a.k.a. packetized elementary stream) within the TS. Hence, a logical channel within an MPEG-2 TS may be considered to correspond to a specific PID value.

Available media file format standards include ISO base media file format (ISO/IEC 14496-12, which may be abbreviated ISOBMFF) and file format for NAL unit structured video (ISO/IEC 14496-15), which derives from the ISOBMFF.

A video codec consists of an encoder that transforms the input video into a compressed representation suited for storage/transmission and a decoder that can uncompress the compressed video representation back into a viewable form. A video encoder and/or a video decoder may also be separate from each other, i.e. need not form a codec. Typically the encoder discards some information in the original video sequence in order to represent the video in a more compact form (that is, at lower bitrate).

Typical hybrid video encoders, for example many encoder implementations of ITU-T H.263 and H.264, encode the video information in two phases. Firstly pixel values in a certain picture area (or “block”) are predicted for example by motion compensation means (finding and indicating an area in one of the previously coded video frames that corresponds closely to the block being coded) or by spatial means (using the pixel values around the block to be coded in a specified manner). Secondly the prediction error, i.e. the difference between the predicted block of pixels and the original block of pixels, is coded. This is typically done by transforming the difference in pixel values using a specified transform (e.g. Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size or transmission bitrate).

In temporal prediction, the sources of prediction are previously decoded pictures (a.k.a. reference pictures). In intra block copy (IBC; a.k.a. intra-block-copy prediction and current picture referencing), prediction is applied similarly to temporal prediction but the reference picture is the current picture and only previously decoded samples can be referred in the prediction process. Inter-layer or inter-view prediction may be applied similarly to temporal prediction, but the reference picture is a decoded picture from another scalable layer or from another view, respectively. In some cases, inter prediction may refer to temporal prediction only, while in other cases inter prediction may refer collectively to temporal prediction and any of intra block copy, inter-layer prediction, and inter-view prediction provided that they are performed with the same or similar process as temporal prediction. Inter prediction or temporal prediction may sometimes be referred to as motion compensation or motion-compensated prediction.

Inter prediction, which may also be referred to as temporal prediction, motion compensation, or motion-compensated prediction, reduces temporal redundancy. In inter prediction the sources of prediction are previously decoded pictures. Intra prediction utilizes the fact that adjacent pixels within the same picture are likely to be correlated. Intra prediction can be performed in the spatial or transform domain, i.e., either sample values or transform coefficients can be predicted. Intra prediction is typically exploited in intra coding, where no inter prediction is applied.

One outcome of the coding procedure is a set of coding parameters, such as motion vectors and quantized transform coefficients. Many parameters can be entropy-coded more efficiently if they are predicted first from spatially or temporally neighboring parameters. For example, a motion vector may be predicted from spatially adjacent motion vectors and only the difference relative to the motion vector predictor may be coded. Prediction of coding parameters and intra prediction may be collectively referred to as in-picture prediction.

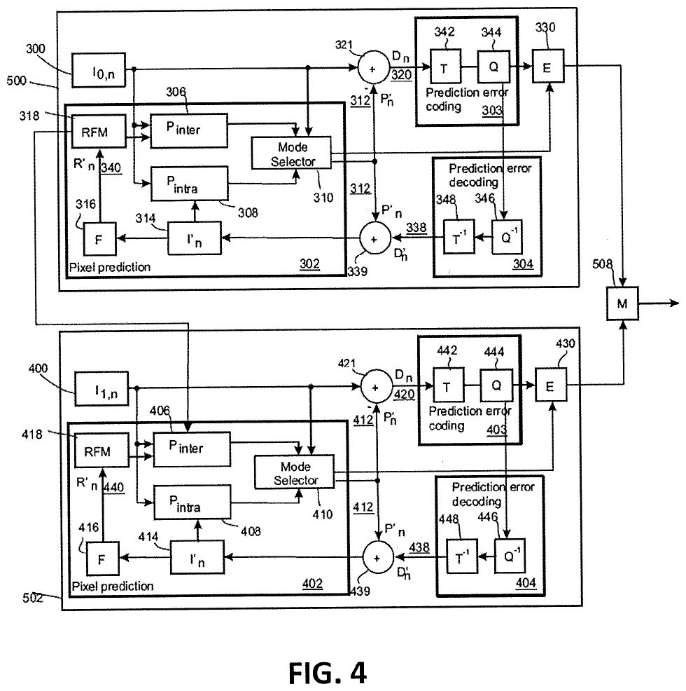

FIG. 4 shows a block diagram of a general structure of a video encoder. FIG. 4 presents an encoder for two layers, but it would be appreciated that presented encoder could be similarly extended to encode more than two layers. FIG. 4 illustrates a video encoder comprising a first encoder section 500 for a base layer and a second encoder section 502 for an enhancement layer. Each of the first encoder section 500 and the second encoder section 502 may comprise similar elements for encoding incoming pictures. The encoder sections 500, 502 may comprise a pixel predictor 302, 402, prediction error encoder 303, 403 and prediction error decoder 304, 404. FIG. 4 also shows an embodiment of the pixel predictor 302, 402 as comprising an inter-predictor 306, 406 (Pᵢₙₜₑᵣ), an intra-predictor 308, 408 (Pᵢₙₜᵣₐ), a mode selector 310, 410, a filter 316, 416 (F), and a reference frame memory 318, 418 (RFM). The pixel predictor 302 of the first encoder section 500 receives 300 base layer images (I_{0,n}) of a video stream to be encoded at both the inter-predictor 306 (which determines the difference between the image and a motion compensated reference frame 318) and the intra-predictor 308 (which determines a prediction for an image block based only on the already processed parts of the current frame or picture). The output of both the inter-predictor and the intra-predictor are passed to the mode selector 310. The intra-predictor 308 may have more than one intra-prediction modes. Hence, each mode may perform the intra-prediction and provide the predicted signal to the mode selector 310. The mode selector 310 also receives a copy of the base layer picture 300. Correspondingly, the pixel predictor 402 of the second encoder section 502 receives 400 enhancement layer images (I_{1,n}) of a video stream to be encoded at both the inter-predictor 406 (which determines the difference between the image and a motion compensated reference frame 418) and the intra-predictor 408 (which determines a prediction for an image block based only on the already processed parts of the current frame or picture). The output of both the inter-predictor and the intra-predictor are passed to the mode selector 410. The intra-predictor 408 may have more than one intra-prediction modes. Hence, each mode may perform the intra-prediction and provide the predicted signal to the mode selector 410. The mode selector 410 also receives a copy of the enhancement layer picture 400.

Depending on which encoding mode is selected to encode the current block, the output of the inter-predictor 306, 406 or the output of one of the optional intra-predictor modes or the output of a surface encoder within the mode selector is passed to the output of the mode selector 310, 410. The output of the mode selector is passed to a first summing device 321, 421. The first summing device may subtract the output of the pixel predictor 302, 402 from the base layer picture 300/enhancement layer picture 400 to produce a first prediction error signal 320, 420 (Dₙ) which is input to the prediction error encoder 303, 403.

The pixel predictor 302, 402 further receives from a preliminary reconstructor 339, 439 the combination of the prediction representation of the image block 312, 412 (P′ₙ) and the output 338, 438 (D′ₙ) of the prediction error decoder 304, 404. The preliminary reconstructed image 314, 414 (I′ₙ) may be passed to the intra-predictor 308, 408 and to the filter 316, 416. The filter 316, 416 receiving the preliminary representation may filter the preliminary representation and output a final reconstructed image 340, 440 (R′ₙ) which may be saved in a reference frame memory 318, 418. The reference frame memory 318 may be connected to the inter-predictor 306 to be used as the reference image against which a future base layer picture 300 is compared in inter-prediction operations. Subject to the base layer being selected and indicated to be the source for inter-layer sample prediction and/or inter-layer motion information prediction of the enhancement layer according to some embodiments, the reference frame memory 318 may also be connected to the inter-predictor 406 to be used as the reference image against which a future enhancement layer picture 400 is compared in inter-prediction operations. Moreover, the reference frame memory 418 may be connected to the inter-predictor 406 to be used as the reference image against which a future enhancement layer picture 400 is compared in inter-prediction operations.

Filtering parameters from the filter 316 of the first encoder section 500 may be provided to the second encoder section 502 subject to the base layer being selected and indicated to be the source for predicting the filtering parameters of the enhancement layer according to some embodiments.

The prediction error encoder 303, 403 comprises a transform unit 342, 442 (T) and a quantizer 344, 444 (Q). The transform unit 342, 442 transforms the first prediction error signal 320, 420 to a transform domain. The transform is, for example, the DCT transform. The quantizer 344, 444 quantizes the transform domain signal, e.g. the DCT coefficients, to form quantized coefficients.

The prediction error decoder 304, 404 receives the output from the prediction error encoder 303, 403 and performs the opposite processes of the prediction error encoder 303, 403 to produce a decoded prediction error signal 338, 438 which, when combined with the prediction representation of the image block 312, 412 at the second summing device 339, 439, produces the preliminary reconstructed image 314, 414. The prediction error decoder 304, 404 may be considered to comprise a dequantizer 346, 446 (Q⁻¹), which dequantizes the quantized coefficient values, e.g. DCT coefficients, to reconstruct the transform signal and an inverse transformation unit 348, 448 (T⁻¹), which performs the inverse transformation to the reconstructed transform signal wherein the output of the inverse transformation unit 348, 448 contains reconstructed block(s). The prediction error decoder may also comprise a block filter which may filter the reconstructed block(s) according to further decoded information and filter parameters.

The entropy encoder 330, 430 (E) receives the output of the prediction error encoder 303, 403 and may perform a suitable entropy encoding/variable length encoding on the signal to provide error detection and correction capability. The outputs of the entropy encoders 330, 430 may be inserted into a bitstream e.g. by a multiplexer 508 (M).

Compression of neural networks is an active area of research that consists of several use cases and scenarios. One of the scenarios is the compression of weight updates for incremental training of neural networks. In this scenario, the weight updates of a neural network, including the accumulated gradient change during the training over a long enough period of time, e.g. one epoch, are compressed and communicated from one device/node to another device/node. This is a crucial step in some of the training schemes, e.g., federated learning where several devices and institutes train a model collaboratively without sharing and revealing their local private data.

MPEG neural network compression (NNC) activity studies various activities related to the compression of neural networks and compression of weight updates.

In incremental compression of neural networks, i.e., when weight updates are compressed, an algorithm may decide to skip sending complete or partial weight updates. For example, the algorithm realizes that its accuracy to communication ratio is minimal or close to zero and may decide to postpone sending the weight update.

There is a relationship between the entropy of weights and the performance of a model during training. That is if a model is at its peak accuracy and the accuracy is stable, the entropy decreases.

The research about entropy and accuracy is concerned about the training of neural networks where no compression is involved. Nonetheless, the herein described method is concerned with weight updates that could not be directly derived from, as such, the relationship between entropy and accuracy in complex artificial neural networks. According to the relationship between entropy and accuracy in complex artificial neural networks, it is possible to conclude that utilizing entropy for determining the communication of the weight updates could be simply achieved by keeping the history of entropy of weights, and stop communicating them once the entropy does not change. Nonetheless, that does not result in a proper measure for not communicating the weight updates over the period of training, but a measure for early stopping the training of a neural network. The herein described method alternatively explains how to utilize the concepts of information such as entropy for skipping a weight update communication in the middle of training process.

A trivial approach to determine if a weight update is to be communicated could be analyzing the performance of a decompressed weight update applied to a model. The steps could consist of (1) compressing the weight update, (2) decompressing the weight update, (3) applying the decompressed weight update to a base model, (4) evaluating the updated model, and (5) if the performance is not better than the base model (e.g., decided by a threshold on n differences of performance of the base model and updated model), not sending a compressed weight update. The herein described method is an alternative approach to determine goodness of a weight update without going through the process of compression, decompression and model evaluation.

In MPEG NNC[ISO/IEC 15938-17:xxxx(E), ISO JTC 1/SC 29/WG 11], high-level syntax allows skipping rows of matrices that have rows consisting of zeros, known as row-skip.

The current NNC specification includes a NDU skipping mechanism under the implementation of a technology named parameter update tree (PUT). When the PUT is enabled, the standard could skip sending NDUs that are specific to a tensor that contain all zeros.

The row-skip and PUT NDU skipping allows skipping information at the tensor level based on content of a tensor.

In contrast to existing technologies and HLS that operate at the tensor level, the examples described herein are concerned with model level skipping of information. For example, the system may skip sending the whole model.

The examples described herein involve two aspects: 1) a method and technique for determining whether to skip the communication of weight updates independent of tensor content and trivial validation schemes, and 2) semantics and high-level syntax definitions to allow skipping weight updates at the model level, independent of the weight update values (tensor content). That is, in the examples described herein, the complete weight update could be skipped even if the tensors are not zero or do not have a specific pattern of zeros (e.g., zero rows).

### Definitions

W₀: is the weights of a neural network base model.
W₁: is the weights of a network after the i-th epoch of training
ΔWᵢⁱ⁺¹: is the weight update obtained between epoch i and i+1, where it could be calculated as the difference of weights that is ΔWᵢⁱ⁺¹=Wᵢ₊₁−Wᵢ
α: is a tolerance value
ϕ(.): is a normalizing function that maps an input tensor into a distribution representation, for example, by applying a softmax operation or similar normalization techniques.
   Communicating Weight Updates Based on their Entropy Using a Common Reference Model

For determining the weight updates to be communicated using entropy, the following solution is described:

Given W₀, Wᵢ, Wₜ where i<t, and where the weight updates with respect to Wₜ have already been sent, the following algorithm could be used:
1. Eₜ=Enₜropy(ΔW₀ⁱ)
2. Eₜ=Enₜropy(ΔW₀^{t})
3. if Eₜ>Eᵢ+α
   communicate ΔWᵢ^{t}
      The ΔWᵢ^{t} could be calculated given that a device has access to a reference model and previously communicated model weights.
      Communicating Weight Updates Based on their KL-Divergence Using a Common Reference Model

Alternatively, to decide communicating weight updates at time t, the herein described method uses the KL-divergence.

Given W₀, Wᵢ, Wₜ where i<t, and where the weight updates with respect to Wᵢ have already been sent, the following algorithm could be used:

Normalize \dot{W}₀=ϕ(W₀), \dot{W}ᵢ=ϕ(Wᵢ), \dot{W}ₜ=ϕ(Wₜ) and apply the following procedure
1. Kᵢ=KLdᵢvergence(\dot{W}₀, \dot{W}ᵢ)
2. Kₜ=KLdᵢvergence(\dot{W}₀, \dot{W}ₜ)
3. if Kₜ>Kᵢ+α
   communicate ΔWᵢ^{t}

The ΔWᵢ^{t} could be calculated given that a device has access to a reference model and previously communicated model weights.

### Syntax and Semantics

Once a device decides that a weight update would be available for sending, it will signal the receiver that there is a weight update available and the base model id is also provided.

The bitstream may contain the following information:
weight_update_present_flag: indicates if a weight update is present in the payload
weight_update_base_present_flag: indicates if a weight update is present and the base model information is present
base_model_id: indicates the identifier of the base model to which the weight-update is to be applied, alternatively one may call this “parent_node_id” running at a model level.

The base_model_id could have several implementations which allow for having some reserved values. One such value could be used for allowing using NDU level encoding of IDs. For example, in case of a null terminated string the base_model_id could have the following reserved value:
“ndu_enabled”: if the value is equal to “ndu_enabled” the ndu level id's will be used
ndu_put_flag: indicates if the parameter update tree at the NDU level is used to reference the parent parameters.

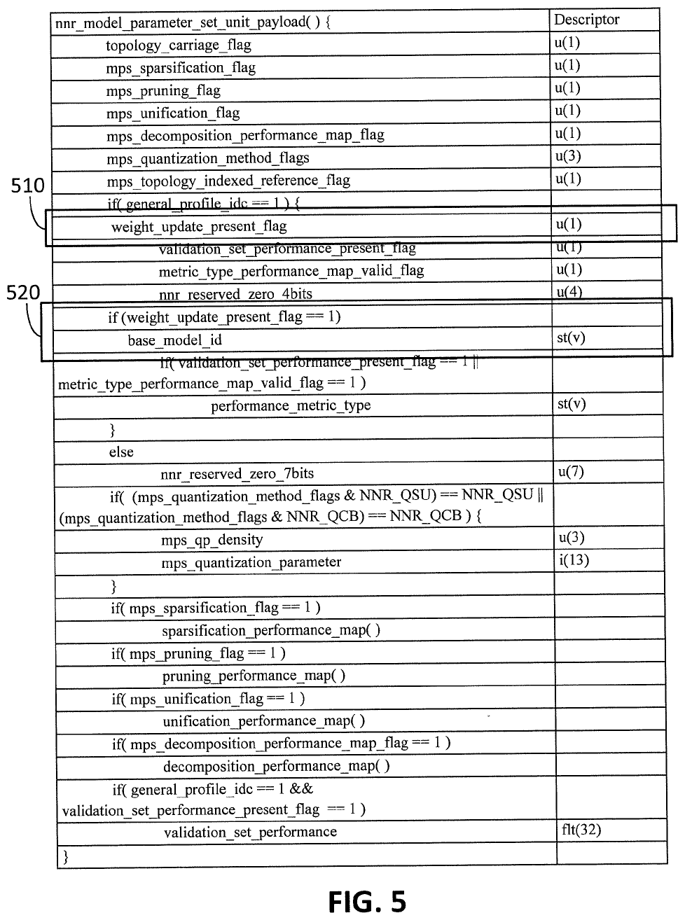

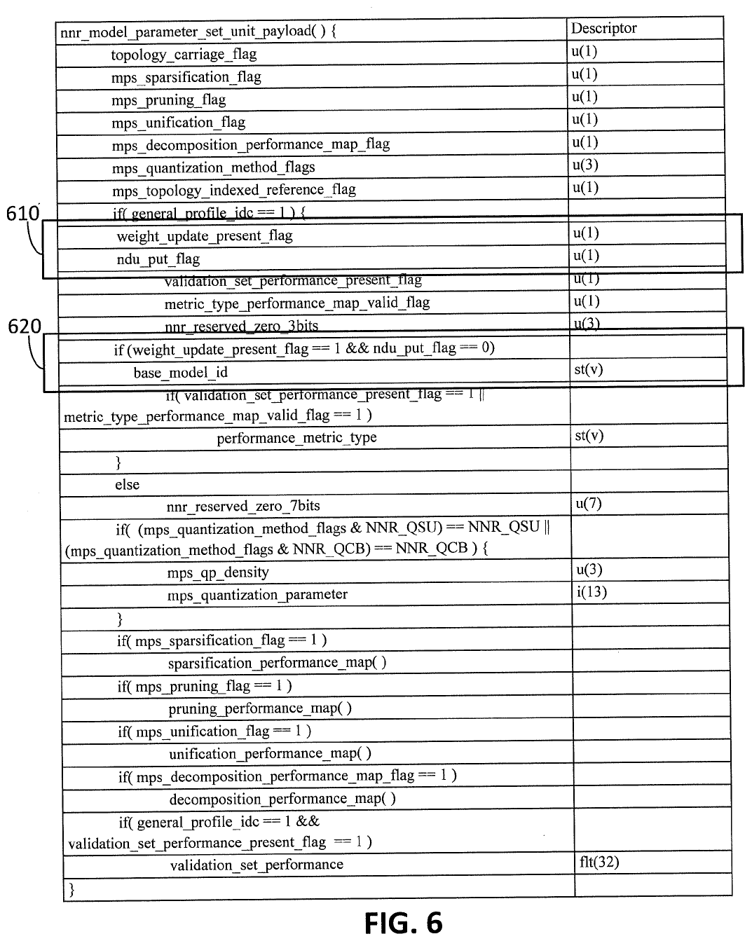

The proposed semantical elements could be implemented as part of the model_parameter_set in the MPEG NNR/NNC standard, where an example implementation is provided below as example syntax 1 (also shown in FIG. 5) and example syntax 2 (also shown in FIG. 6), where items 510 and 520 of FIG. 5 and items 610 and 620 of FIG. 6 indicate the changes.

### Example Syntax 1

| | De- |
|---|---|
| | scriptor |
| nnr_model_parameter_set_unit_payload( ) { | |
| topology_carriage_flag | u(1) |
| mps_sparsification_flag | u(1) |
| mps_pruning_flag | u(1) |
| mps_unification_flag | u(1) |
| mps_decomposition_performance_map_flag | u(1) |
| mps_quantization_method_flags | u(3) |
| mps_topology_indexed_reference_flag | u(1) |
| if( general_profile_idc == 1 ) { | |
| weight_update_present_flag | u(1) |
| validation_set_performance_present_flag | u(1) |
| metric_type_performance_map_valid_flag | u(1) |
| nnr_reserved_zero_4bits | u(4) |
| if (weight_update_present_flag == 1) | |
| base_model_id | st(v) |
| if( validation_set_performance_present_flag == 1 ∥ | |
| metric_type_performance_map_valid_flag == 1 ) | |
| performance_metric_type | st(v) |
| } | |
| else | |
| nnr_reserved_zero_7bits | u(7) |
| if( (mps_quantization_method_flags & NNR_QSU) == | |
| NNR_QSU ∥ (mps_quantization_method_flags & NNR_QCB) == | |
| NNR_QCB ) { | |
| mps_qp_density | u(3) |
| mps_quantization_parameter | i(13) |
| } | |
| if( mps_sparsification_flag == 1 ) | |
| sparsification_performance_map( ) | |
| if( mps_pruning_flag == 1 ) | |
| pruning_performance_map( ) | |
| if( mps_unification_flag == 1 ) | |
| unification_performance_map( ) | |
| if( mps_decomposition_performance_map_flag == 1 ) | |
| decomposition_performance_map( ) | |
| if( general_profile_idc == 1 && | |
| validation_set_performance_present_flag = 1 ) | |
| validation_set_performance | flt(32) |
| } | |

### Example Syntax 2

| | De- |
|---|---|
| | scriptor |
| nnr_model_parameter_set_unit_payload( ) { | |
| topology_carriage_flag | u(1) |
| mps_sparsification_flag | u(1) |
| mps_pruning_flag | u(1) |
| mps_unification_flag | u(1) |
| mps_decomposition_performance_map_flag | u(1) |
| mps_quantization_method_flags | u(3) |
| mps_topology_indexed_reference_flag | u(1) |
| if( general_profile_idc == 1 ) { | |
| weight_update_present_flag | u(1) |
| ndu_put_flag | u(1) |
| validation_set_performance_present_flag | u(1) |
| metric_type_performance_map_valid flag | u(1) |
| nnr_reserved_zero_3bits | u(3) |
| if (weight_update_present_flag == 1 && ndu_put_flag == 0) | |
| base_model_id | st(v) |
| if( validation_set_performance_present_flag == 1 ∥ | |
| metric_type_performance_map_valid_flag == 1 ) | |
| performance_metric_type | st(v) |
| } | |
| else | |
| nnr_reserved_zero_7bits | u(7) |
| if( (mps_quantization_method_flags & NNR_QSU) == | |
| NNR_QSU ∥ (mps_quantization_method_flags & NNR_QCB) == | |
| NNR_QCB ) { | |
| mps_qp_density | u(3) |
| mps_quantization parameter | i(13) |
| } | |
| if( mps_sparsification_flag == 1 ) | |
| sparsification_performance_map( ) | |
| if( mps_pruning_flag == 1 ) | |
| pruning_performance_map( ) | |
| if( mps_unification_flag == 1 ) | |
| unification_performance_map( ) | |
| if( mps_decomposition_performance_map_flag == 1 ) | |
| decomposition_performance_map( ) | |
| if( general_profile_idc == 1 && | |
| validation_set_performance_present_flag == 1 ) | |
| validation_set_performance | flt(32) |
| } | |

The base_model_id may be set by a device to be equal to an ID that identifies a base model, here referred to as model_ID. The model_ID may be communicated by a server to the device. In one example, the model_ID is communicated by the server to the device when the model is first communicated to the device, in the form of a value of a high-level syntax element. Alternatively, the model_ID may be created and kept up-to-date at both device side and server side. In one example, the model_ID can be a number that is incremented by 1 at each communication round.

Embodiments are not limited to any particular data type or format of the base model identifier. For example, the base model identifier may be a NULL-terminated string or an unsigned integer of a pre-defined length. Identifier values may be assigned based on a pre-defined scheme that may be specified for example in NNC or the neural network framework or specification used in describing the model. Alternatively, identifier values may be provided as URIs, UUIDs or alike. Alternatively, a hash value or a checksum may be used as a base model identifier value, wherein the hash value or checksum may be derived from a representation of the base model, such as from the NNC bitstream of the base model, using a pre-defined or indicated hash function.

A uniform resource identifier (URI) may be defined as a string of characters used to identify a name of a resource. Such identification enables interaction with representations of the resource over a network, using specific protocols. A URI is defined through a scheme specifying a concrete syntax and associated protocol for the URI. The uniform resource locator (URL) and the uniform resource name (URN) are forms of a URI. A URL may be defined as a URI that identifies a web resource and specifies the means of acting upon or obtaining the representation of the resource, specifying both its primary access mechanism and network location. A URN may be defined as a URI that identifies a resource by name in a particular namespace. A URN may be used for identifying a resource without implying its location or how to access it.

A universally unique identifier (UUID) is usually a 128-bit number used to identify information in computer systems and may be derived from a media access control address (MAC address) and a present time (e.g. the encoding time of the shared coded picture, e.g. in terms of Coordinated Universal Time).

A hash function may be defined as any function that can be used to map digital data of arbitrary size to digital data of fixed size, with slight differences in input data possibly producing big differences in output data. A cryptographic hash function may be defined as a hash function that is intended to be practically impossible to invert, i.e. to create the input data based on the hash value alone. A cryptographic hash function may comprise e.g. the MD5 function. An MD5 value may be a null-terminated string of UTF-8 characters containing a base64 encoded MD5 digest of the input data. One method of calculating the string is specified in IETF RFC 1864. It should be understood that instead of or in addition to MD5, other types of integrity check schemes could be used in various embodiments, such as different forms of the cyclic redundancy check (CRC), such as the CRC scheme used in ITU-T Recommendation H.271.

A checksum or hash sum may be defined as a small-size datum from an arbitrary block of digital data which may be used for the purpose of detecting errors which may have been introduced during its transmission or storage. The actual procedure which yields the checksum, given a data input may be called a checksum function or checksum algorithm. A checksum algorithm will usually output a significantly different value, even for small changes made to the input. This is especially true of cryptographic hash functions, which may be used to detect many data corruption errors and verify overall data integrity; if the computed checksum for the current data input matches the stored value of a previously computed checksum, there is a high probability the data has not been altered or corrupted. The term checksum may be defined to be equivalent to a cryptographic hash value or alike.

### Decoding Operations

At the decoder side, when weight_update_present_flag is set to 1, the decoder may proceed with decoding the payload of the NDUs, and apply the decoded weight-update to the base model.

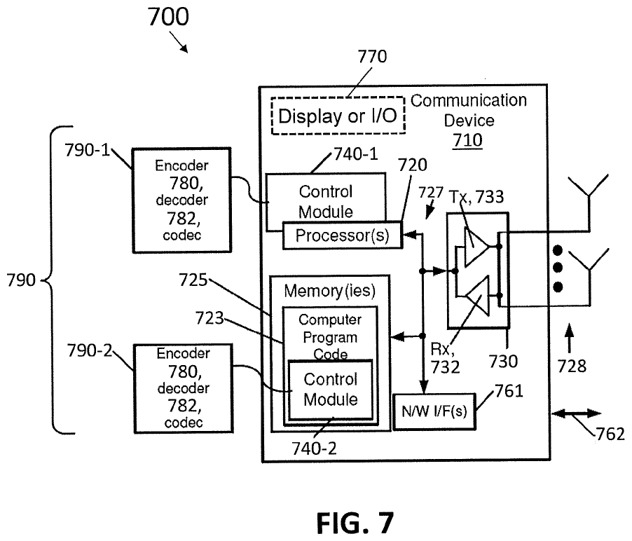

FIG. 7 is a block diagram 700 of an apparatus 710 suitable for implementing the exemplary embodiments. One nonlimiting example of the apparatus 710 is a wireless, typically mobile device that can access a wireless network. The apparatus 710 includes one or more processors 720, one or more memories 725, one or more transceivers 730, and one or more network (N/W) interfaces (I/F(s)) 761, interconnected through one or more buses 727. Each of the one or more transceivers 730 includes a receiver, Rx, 732 and a transmitter, Tx, 733. The one or more buses 727 may be address, data, or control buses, and may include any interconnection mechanism, such as a series of lines on a motherboard or integrated circuit, optics fiber or other optical communication equipment, and the like.

The apparatus 710 may communicate via wired, wireless, or both interfaces. For wireless communication, the one or more transceivers 730 are connected to one or more antennas 728. The one or more memories 725 include computer program code 723. The N/W I/F(s) 761 communicate via one or more wired links 762.

The apparatus 710 includes a control module 740, comprising one of or both parts 740-1 and/or 740-2, which include reference 790 that includes encoder 780, or decoder 782, or a codec of both 780/782, and which may be implemented in a number of ways. For ease of reference, reference 790 is referred to herein as a codec. The control module 740 may be implemented in hardware as control module 740-1, such as being implemented as part of the one or more processors 720. The control module 740-1 may be implemented also as an integrated circuit or through other hardware such as a programmable gate array. In another example, the control module 740 may be implemented as control module 740-2, which is implemented as computer program code 723 and is executed by the one or more processors 720. For instance, the one or more memories 725 and the computer program code 723 may be configured to, with the one or more processors 1020, cause the user equipment 710 to perform one or more of the operations as described herein. The codec 790 may be similarly implemented as codec 790-1 as part of control module 740-1, or as codec 790-2 as part of control module 740-2, or both.

The computer readable memories 725 may be of any type suitable to the local technical environment and may be implemented using any suitable data storage technology, such as semiconductor-based memory devices, flash memory, firmware, magnetic memory devices and systems, optical memory devices and systems, fixed memory and removable memory. The computer readable memories 725 may be means for performing storage functions. The computer readable one or more memories 725 may be non-transitory, transitory, volatile (e.g. random access memory (RAM)) or non-volatile (e.g. read-only memory (ROM)). The computer readable one or more memories 725 may comprise a database for storing data.

The processors 720 may be of any type suitable to the local technical environment, and may include one or more of general-purpose computers, special purpose computers, microprocessors, digital signal processors (DSPs) and processors based on a multi-core processor architecture, as non-limiting examples. The processors 720 may be means for performing functions, such as controlling the apparatus 710, and other functions as described herein.

In general, the various embodiments of the apparatus 710 can include, but are not limited to, cellular telephones (such as smart phones, mobile phones, cellular phones, voice over Internet Protocol (IP) (VOIP) phones, and/or wireless local loop phones), tablets, portable computers, room audio equipment, immersive audio equipment, vehicles or vehicle-mounted devices for, e.g., wireless V2X (vehicle-to-everything) communication, image capture devices such as digital cameras, gaming devices, music storage and playback appliances, Internet appliances (including Internet of Things, IoT, devices), IoT devices with sensors and/or actuators for, e.g., automation applications, as well as portable units or terminals that incorporate combinations of such functions, laptops, laptop-embedded equipment (LEE), laptop-mounted equipment (LME), Universal Serial Bus (USB) dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain context), a consumer electronics device, a device operating on commercial and/or industrial wireless networks, and the like. That is, the apparatus 710 could be any device that may be capable of wireless or wired communication.

Thus, the apparatus 710 comprises a processor 720, at least one memory 725 including computer program code 723, wherein the at least one memory 725 and the computer program code 723 are configured to, with the at least one processor 720, cause the apparatus 710 to implement model level update skipping in compressed incremental learning 790 in neural network compression, based on the examples described herein. The apparatus 710 optionally includes a display or I/O 770 that may be used to display content during ML/task/machine/NN processing or rendering. Display or I/O 770 may be configured to receive input from a user, such as with a keypad, touchscreen, touch area, microphone, biometric recognition etc. Apparatus 710 may comprise standard well-known components such as an amplifier, filter, frequency-converter, and (de) modulator.

Computer program code 723 may comprise object oriented software, and may implement the syntax shown in FIG. 5 and FIG. 6. The apparatus 710 need not comprise each of the features mentioned, or may comprise other features as well. The apparatus 710 may be an embodiment of apparatuses shown in FIG. 1, FIG. 2, FIG. 3, or FIG. 4, including any combination of those.

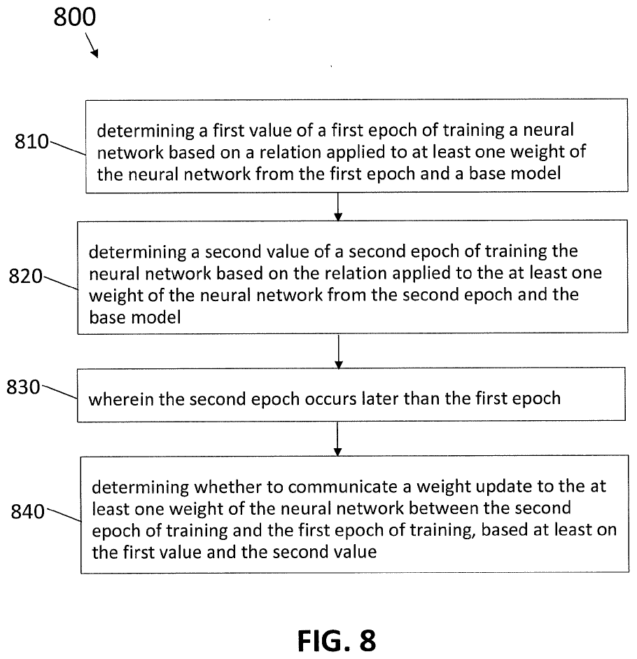

FIG. 8 is an example method 800 to implement model level update skipping in compressed incremental learning, based on the examples described herein. At 810, the method includes determining a first value of a first epoch of training a neural network based on a relation applied to at least one weight of the neural network from the first epoch and a base model. At 820, the method includes determining a second value of a second epoch of training the neural network based on the relation applied to the at least one weight of the neural network from the second epoch and the base model. At 830, the method includes wherein the second epoch occurs later than the first epoch. At 840, the method includes determining whether to communicate a weight update to the at least one weight of the neural network between the second epoch of training and the first epoch of training, based at least on the first value and the second value. Method 800 may be performed by an encoder, or any of the apparatuses shown in FIG. 1, FIG. 2, FIG. 3, FIG. 4, or FIG. 7.

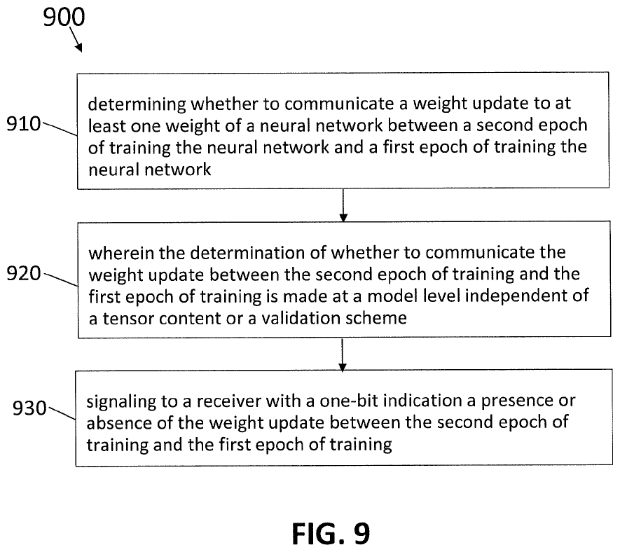

FIG. 9 is an example method 900 to implement model level update skipping in compressed incremental learning, based on the examples described herein. At 910, the method includes determining whether to communicate a weight update to at least one weight of a neural network between a second epoch of training the neural network and a first epoch of training the neural network. At 920, the method includes wherein the determination of whether to communicate the weight update between the second epoch of training and the first epoch of training is made at a model level independent of a tensor content or a validation scheme. At 930, the method includes signaling to a receiver with a one-bit indication a presence or absence of the weight update between the second epoch of training and the first epoch of training. Method 900 may be performed by an encoder, or any of the apparatuses shown in FIG. 1, FIG. 2, FIG. 3, FIG. 4, or FIG. 7.

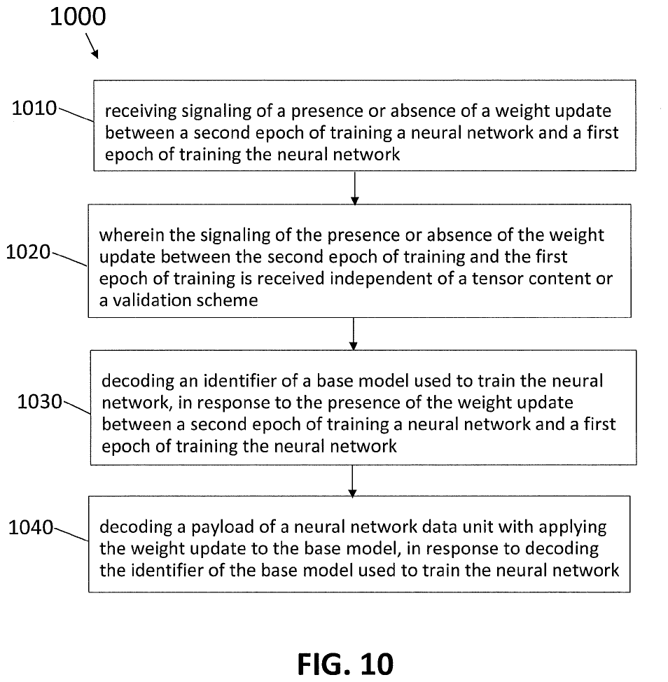

FIG. 10 is an example method 1000 to implement model level update skipping in compressed incremental learning, based on the examples described herein. At 1010, the method includes receiving signaling of a presence or absence of a weight update between a second epoch of training a neural network and a first epoch of training the neural network. At 1020, the method includes wherein the signaling of the presence or absence of the weight update between the second epoch of training and the first epoch of training is received independent of a tensor content or a validation scheme. At 1030, the method includes decoding an identifier of a base model used to train the neural network, in response to the presence of the weight update between a second epoch of training a neural network and a first epoch of training the neural network. At 1040, the method includes decoding a payload of a neural network data unit with applying the weight update to the base model, in response to decoding the identifier of the base model used to train the neural network. Method 1000 may be performed by a decoder, or any of the apparatuses shown in FIG. 1, FIG. 2, FIG. 3, FIG. 4, or FIG. 7.

References to a ‘computer’, ‘processor’, etc. should be understood to encompass not only computers having different architectures such as single/multi-processor architectures and sequential/parallel architectures but also specialized circuits such as field-programmable gate arrays (FPGAS), application specific circuits (ASICs), signal processing devices and other processing circuitry. References to computer program, instructions, code etc. should be understood to encompass software for a programmable processor or firmware such as, for example, the programmable content of a hardware device such as instructions for a processor, or configuration settings for a fixed-function device, gate array or programmable logic device, etc.

As used herein, the term ‘circuitry’, ‘circuit’ and variants may refer to any of the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device. Circuitry or circuit may also be used to mean a function or a process used to execute a method.

The following examples (1-41) are described and provided herein.

Example 1: An apparatus includes at least one processor; and at least one memory including computer program code; wherein the at least one memory and the computer program code are configured to, with the at least one processor, cause the apparatus at least to: determine a first value of a first epoch of training a neural network based on a relation applied to at least one weight of the neural network from the first epoch and a base model; determine a second value of a second epoch of training the neural network based on the relation applied to the at least one weight of the neural network from the second epoch and the base model; wherein the second epoch occurs later than the first epoch; and determine whether to communicate a weight update to the at least one weight of the neural network between the second epoch of training and the first epoch of training, based at least on the first value and the second value.

Example 2: The apparatus of example 1, wherein the at least one memory and the computer program code are further configured to, with the at least one processor, cause the apparatus at least to: determine a first set of weights of the neural network after the first epoch of training the neural network; determine a second set of weights of the neural network after the second epoch of training the neural network; and determine the weight update between the second epoch and the first epoch as a difference between the second set of weights and the first set of weights.

Example 3: The apparatus of any of examples 1 to 2, wherein the at least one memory and the computer program code are further configured to, with the at least one processor, cause the apparatus at least to: determine the first value as a first entropy of a weight update of the neural network between the first epoch and the base model; determine the second value as a second entropy of a weight update of the neural network between the second epoch and the base model; and determine to communicate the weight update between the second epoch of training and the first epoch of training, in response to the second value being greater than the first value added to a tolerance value.

Example 4: The apparatus of any of examples 1 to 3, wherein the at least one memory and the computer program code are further configured to, with the at least one processor, cause the apparatus at least to: determine the first value as a Kullback-Leibler divergence applied to normalized weights of the neural network after the first epoch of training and normalized weights of the base model; determine the second value as the Kullback-Leibler divergence applied to normalized weights of the neural network after the second epoch of training and the normalized weights of the base model; and determine to communicate the weight update between the second epoch of training and the first epoch of training, in response to the second value being greater than the first value added to a tolerance value.

Example 5: The apparatus of any of examples 1 to 4, wherein an update to the at least one weight of the neural network after the first epoch of training has been communicated prior to the determining of whether to communicate the weight update between the second epoch of training and the first epoch of training.

Example 6: The apparatus of any of examples 1 to 5, wherein the at least one memory and the computer program code are further configured to, with the at least one processor, cause the apparatus at least to: signal to a receiver with a one-bit indication a presence or absence of the weight update between the second epoch of training and the first epoch of training; and signal to the receiver an identifier of the base model, in response to the presence of the weight update between the second epoch of training and the first epoch of training.

Example 7: The apparatus of example 6, wherein the signaling of the presence or absence of the weight update between the second epoch of training and the first epoch of training is part of a model parameter set syntax; and wherein the signaling of the identifier of the base model is part of the model parameter set syntax.

Example 8: The apparatus of any of examples 1 to 7, wherein the at least one memory and the computer program code are further configured to, with the at least one processor, cause the apparatus at least to: signal a one-bit flag indicating a presence of both the weight update between the second epoch of training and the first epoch of training, and information related to the base model.

Example 9: The apparatus of any of examples 1 to 8, wherein the at least one memory and the computer program code are further configured to, with the at least one processor, cause the apparatus at least to: signal to a receiver with a one-bit indication whether a parameter update tree is used to reference parameters of the base model.

Example 10: The apparatus of any of examples 1 to 9, wherein the at least one memory and the computer program code are further configured to, with the at least one processor, cause the apparatus at least to: signal to a receiver with a one-bit indication a presence or absence of the weight update between the second epoch of training and the first epoch of training; signal to the receiver with a one-bit indication whether a parameter update tree is used to reference parameters of the base model; and signal information that an identifier of a base model is present, in response to the presence of the weight update between the second epoch of training and the first epoch of training, and the parameter update tree not being used to reference parameters of the base model.

Example 11: An apparatus includes at least one processor; and at least one memory including computer program code; wherein the at least one memory and the computer program code are configured to, with the at least one processor, cause the apparatus at least to: determine whether to communicate a weight update to at least one weight of a neural network between a second epoch of training the neural network and a first epoch of training the neural network; wherein the determination of whether to communicate the weight update between the second epoch of training and the first epoch of training is made at a model level independent of a tensor content or a validation scheme; and signal to a receiver with a one-bit indication a presence or absence of the weight update between the second epoch of training and the first epoch of training.

Example 12: The apparatus of example 11, wherein the at least one memory and the computer program code are further configured to, with the at least one processor, cause the apparatus at least to: signal to the receiver an identifier of a base model used to determine whether to communicate the weight update.

Example 13: The apparatus of example 12, wherein the signaling of the presence or absence of the weight update between the second epoch of training and the first epoch of training is part of a model parameter set syntax; and wherein the signaling of the identifier of the base model is part of the model parameter set syntax.

Example 14: The apparatus of any of examples 11 to 13, wherein the at least one memory and the computer program code are further configured to, with the at least one processor, cause the apparatus at least to: signal to the receiver a one-bit flag indicating a presence of both the weight update between the second epoch of training and the first epoch of training, and information related to the base model.

Example 15: The apparatus of any of examples 11 to 14, wherein the at least one memory and the computer program code are further configured to, with the at least one processor, cause the apparatus at least to: signal to the receiver with a one-bit indication whether a parameter update tree is used to reference parameters of the base model.

Example 16: The apparatus of any of examples 11 to 15, wherein the at least one memory and the computer program code are further configured to, with the at least one processor, cause the apparatus at least to: signal information that an identifier of the base model is present, in response to the presence of the weight update between the second epoch of training and the first epoch of training, and a parameter update tree not being used to reference parameters of the base model; wherein the presence or absence of the weight update between the second epoch of training and the first epoch of training is signaled to the receiver with a one-bit indication; wherein whether the parameter update tree is used to reference parameters of the base model is signaled with a one-bit indication.

Example 17: An apparatus includes at least one processor; and at least one memory including computer program code; wherein the at least one memory and the computer program code are configured to, with the at least one processor, cause the apparatus at least to: receive signaling of a presence or absence of a weight update between a second epoch of training a neural network and a first epoch of training the neural network; wherein the signaling of the presence or absence of the weight update between the second epoch of training and the first epoch of training is received independent of a tensor content or a validation scheme; decode an identifier of a base model used to train the neural network, in response to the presence of the weight update between a second epoch of training a neural network and a first epoch of training the neural network; and decode a payload of a neural network data unit with applying the weight update to the base model, in response to decoding the identifier of the base model used to train the neural network.

Example 18: The apparatus of example 17, wherein the at least one memory and the computer program code are further configured to, with the at least one processor, cause the apparatus at least to: decode a one-bit indication whether a parameter update tree is used to reference parameters of the base model.

Example 19: The apparatus of any of examples 17 to 18, wherein the at least one memory and the computer program code are further configured to, with the at least one processor, cause the apparatus at least to: decode a one-bit indication of the presence or absence of the weight update between the second epoch of training and the first epoch of training; decode a one-bit indication of whether a parameter update tree is used to reference parameters of the base model; and decode the identifier of the base model, in response to decoding the presence of the weight update between the second epoch of training and the first epoch of training, and decoding the parameter update tree not being used to reference parameters of the base model.

Example 20: The apparatus of any of examples 17 to 19, wherein the signaling of the presence or absence of the weight update between the second epoch of training and the first epoch of training part of a model parameter set syntax; and wherein the signaling of the identifier of the base model is part of the model parameter set syntax.

Example 21: A method includes determining a first value of a first epoch of training a neural network based on a relation applied to at least one weight of the neural network from the first epoch and a base model; determining a second value of a second epoch of training the neural network based on the relation applied to the at least one weight of the neural network from the second epoch and the base model; wherein the second epoch occurs later than the first epoch; and determining whether to communicate a weight update to the at least one weight of the neural network between the second epoch of training and the first epoch of training, based at least on the first value and the second value.

Example 22: A method includes determining whether to communicate a weight update to at least one weight of a neural network between a second epoch of training the neural network and a first epoch of training the neural network; wherein the determination of whether to communicate the weight update between the second epoch of training and the first epoch of training is made at a model level independent of a tensor content or a validation scheme; and signaling to a receiver with a one-bit indication a presence or absence of the weight update between the second epoch of training and the first epoch of training.

Example 23: A method includes receiving signaling of a presence or absence of a weight update between a second epoch of training a neural network and a first epoch of training the neural network; wherein the signaling of the presence or absence of the weight update between the second epoch of training and the first epoch of training is received independent of a tensor content or a validation scheme; decoding an identifier of a base model used to train the neural network, in response to the presence of the weight update between a second epoch of training a neural network and a first epoch of training the neural network; and decoding a payload of a neural network data unit with applying the weight update to the base model, in response to decoding the identifier of the base model used to train the neural network.

Example 24: An apparatus includes means for determining a first value of a first epoch of training a neural network based on a relation applied to at least one weight of the neural network from the first epoch and a base model; means for determining a second value of a second epoch of training the neural network based on the relation applied to the at least one weight of the neural network from the second epoch and the base model; wherein the second epoch occurs later than the first epoch; and means for determining whether to communicate a weight update to the at least one weight of the neural network between the second epoch of training and the first epoch of training, based at least on the first value and the second value.

Example 25: An apparatus includes means for determining whether to communicate a weight update to at least one weight of a neural network between a second epoch of training the neural network and a first epoch of training the neural network; wherein the determination of whether to communicate the weight update between the second epoch of training and the first epoch of training is made at a model level independent of a tensor content or a validation scheme; and means for signaling to a receiver with a one-bit indication a presence or absence of the weight update between the second epoch of training and the first epoch of training.

Example 26: An apparatus includes means for receiving signaling of a presence or absence of a weight update between a second epoch of training a neural network and a first epoch of training the neural network; wherein the signaling of the presence or absence of the weight update between the second epoch of training and the first epoch of training is received independent of a tensor content or a validation scheme; means for decoding an identifier of a base model used to train the neural network, in response to the presence of the weight update between a second epoch of training a neural network and a first epoch of training the neural network; and means for decoding a payload of a neural network data unit with applying the weight update to the base model, in response to decoding the identifier of the base model used to train the neural network.

Example 27: A non-transitory program storage device readable by a machine, tangibly embodying a program of instructions executable with the machine for performing operations, the operations comprising: determining a first value of a first epoch of training a neural network based on a relation applied to at least one weight of the neural network from the first epoch and a base model; determining a second value of a second epoch of training the neural network based on the relation applied to the at least one weight of the neural network from the second epoch and the base model; wherein the second epoch occurs later than the first epoch; and determining whether to communicate a weight update to the at least one weight of the neural network between the second epoch of training and the first epoch of training, based at least on the first value and the second value.

Example 28: A non-transitory program storage device readable by a machine, tangibly embodying a program of instructions executable with the machine for performing operations, the operations comprising: determining whether to communicate a weight update to at least one weight of a neural network between a second epoch of training the neural network and a first epoch of training the neural network; wherein the determination of whether to communicate the weight update between the second epoch of training and the first epoch of training is made at a model level independent of a tensor content or a validation scheme; and signaling to a receiver with a one-bit indication a presence or absence of the weight update between the second epoch of training and the first epoch of training.

Example 29: A non-transitory program storage device readable by a machine, tangibly embodying a program of instructions executable with the machine for performing operations, the operations comprising: receiving signaling of a presence or absence of a weight update between a second epoch of training a neural network and a first epoch of training the neural network; wherein the signaling of the presence or absence of the weight update between the second epoch of training and the first epoch of training is received independent of a tensor content or a validation scheme; decoding an identifier of a base model used to train the neural network, in response to the presence of the weight update between a second epoch of training a neural network and a first epoch of training the neural network; and decoding a payload of a neural network data unit with applying the weight update to the base model, in response to decoding the identifier of the base model used to train the neural network.

Example 30: The apparatus of example 1, wherein the at least one memory and the computer program code are further configured to, with the at least one processor, cause the apparatus at least to: receive an identifier of the base model from a server.

Example 31: The apparatus of example 30, wherein the identifier of the base model is received from the server when the base model is first communicated to the apparatus, in the form of a value of a high-level syntax element.

Example 32: The apparatus of example 1, wherein the at least one memory and the computer program code are further configured to, with the at least one processor, cause the apparatus at least to: create an identifier of the base model; and update the identifier of the base model at a communication round.

Example 33: The apparatus of example 32, wherein the identifier of the base model is a number that is incremented by one at each communication round.

Example 34: The apparatus of example 11, wherein the at least one memory and the computer program code are further configured to, with the at least one processor, cause the apparatus at least to: receive an identifier of a base model from a server, the base model used at least partially to determine whether to communicate the weight update.

Example 35: The apparatus of example 34, wherein the identifier of the base model is received from the server when the base model is first communicated to the apparatus, in the form of a value of a high-level syntax element.

Example 36: The apparatus of example 11, wherein the at least one memory and the computer program code are further configured to, with the at least one processor, cause the apparatus at least to: create an identifier of a base model, the base model used at least partially to determine whether to communicate the weight update; and update the identifier of the base model at a communication round.

Example 37: The apparatus of example 36, wherein the identifier of the base model is a number that is incremented by one at each communication round.

Example 38: The apparatus of example 17, wherein the at least one memory and the computer program code are further configured to, with the at least one processor, cause the apparatus at least to: receive an identifier of the base model from a server.

Example 39: The apparatus of example 38, wherein the identifier of the base model is received from the server when the base model is first communicated to the apparatus, in the form of a value of a high-level syntax element.

Example 40: The apparatus of example 17, wherein the at least one memory and the computer program code are further configured to, with the at least one processor, cause the apparatus at least to: create an identifier of the base model; and update the identifier of the base model at a communication round.

Example 41: The apparatus of example 40, wherein the identifier of the base model is a number that is incremented by one at each communication round.

In the figures, arrows between individual blocks represent operational couplings there-between as well as the direction of data flows on those couplings.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

The following acronyms and abbreviations that may be found in the specification and/or the drawing figures are defined as follows:
3GPP 3rd generation partnership project
4G fourth generation of broadband cellular network technology
5G fifth generation cellular network technology
802.x family of IEEE standards dealing with local area networks and metropolitan area networks
ASIC application specific integrated circuit
CDMA code-division multiple access
CPE customer premises equipment
CRC cyclic redundancy check
DCT discrete cosine transform
DSP digital signal processor
FDMA frequency division multiple access
flt(n) floating point number using n bits.
FPGA field programmable gate array
GSM global system for mobile communications
H.222.0 MPEG-2 systems, standard for the generic coding of moving pictures and associated audio information
H.26x family of video coding standards in the domain of the ITU-T
H.271 recommendation related to video back-channel messages for conveyance of status information and requests from a video receiver to a video sender
HLS high level syntax
HMD head mounted display
IBC intra block copy
id or ID identifier
IEC International Electrotechnical Commission
IEEE Institute of Electrical and Electronics Engineers
IETF Internet Engineering Task Force
I/F interface
IMD integrated messaging device
IMS instant messaging service
i(n) signed integer using n bits
I/O input output
IoT internet of things
IP internet protocol
ISO International Organization for Standardization
ISOBMFF ISO base media file format
ITU International Telecommunication Union
ITU-T ITU Telecommunication Standardization Sector
JTC joint technical committee
KL Kullback-Leibler
LEE laptop embedded equipment
LME laptop-mounted equipment
LTE long-term evolution
MAC media access control
MD5 message digest hash function
ML machine learning
MMS multimedia messaging service
MPEG moving picture experts group
MPEG-2 H.222/H.262 as defined by the ITU
MSE mean squared error
NAL network abstraction layer
NDU NNR compressed data unit
NN neural network
NNC MPEG neural network compression standard ISO/IEC 15938-17
NNR MPEG neural network compression standard ISO/IEC 15938-17
N/W network
PC personal computer
PDA personal digital assistant
PID packet identifier
PLC power line communication
PUT parameter update tree
RAM random access memory
RFC request for comments
RFID radio frequency identification
RFM reference frame memory
ROM read-only memory
Rx receiver
SC subcommittee
SMS short messaging service
st(v) null-terminated string encoded as universal coded character set (UCS) transmission format-8 (UTF-8) characters as specified in ISO/IEC 10646
TCP-IP transmission control protocol-internet protocol
TDMA time divisional multiple access.
TS transport stream
TV television
Tx transmitter
UCS universal coded character set
UICC universal integrated circuit card
UMTS universal mobile telecommunications system
u(n) unsigned integer using n bits
URI uniform resource identifier
URL uniform resource locator
URN uniform resource name
USB universal serial bus
UTF UCS transmission format
UUID universally unique identifier
V2X vehicle-to-everything
VOIP voice over IP
VVC versatile video codec
WG working group
WLAN wireless local area network

1. An apparatus comprising:
at least one processor; and
at least one memory storing instructions that, when executed by the at least one processor, cause the apparatus at least to:
determine a first value of a first epoch of training a neural network based on a relation applied to at least one weight of the neural network from the first epoch and a base model;
determine a second value of a second epoch of training the neural network based on the relation applied to the at least one weight of the neural network from the second epoch and the base model;
wherein the second epoch occurs later than the first epoch; and
determine whether to communicate a weight update to the at least one weight of the neural network between the second epoch of training and the first epoch of training, based at least on the first value and the second value.

2. The apparatus of claim 1, wherein the instructions, when executed by the at least one processor, cause the apparatus at least to:
determine a first set of weights of the neural network after the first epoch of training the neural network;
determine a second set of weights of the neural network after the second epoch of training the neural network; and
determine the weight update between the second epoch and the first epoch as a difference between the second set of weights and the first set of weights.

3. The apparatus of claim 1, wherein the instructions, when executed by the at least one processor, cause the apparatus at least to:
determine the first value as a first entropy of a weight update of the neural network between the first epoch and the base model;
determine the second value as a second entropy of a weight update of the neural network between the second epoch and the base model; and
determine to communicate the weight update between the second epoch of training and the first epoch of training, in response to the second value being greater than the first value added to a tolerance value.

4. The apparatus of claim 1, wherein the instructions, when executed by the at least one processor, cause the apparatus at least to:
determine the first value as a Kullback-Leibler divergence applied to normalized weights of the neural network after the first epoch of training and normalized weights of the base model;
determine the second value as the Kullback-Leibler divergence applied to normalized weights of the neural network after the second epoch of training and the normalized weights of the base model; and
determine to communicate the weight update between the second epoch of training and the first epoch of training, in response to the second value being greater than the first value added to a tolerance value.

5. The apparatus of claim 1, wherein an update to the at least one weight of the neural network after the first epoch of training has been communicated prior to the determining of whether to communicate the weight update between the second epoch of training and the first epoch of training.

6. The apparatus of claim 1, wherein the instructions, when executed by the at least one processor, cause the apparatus at least to:
signal to a receiver with a one-bit indication a presence or absence of the weight update between the second epoch of training and the first epoch of training; and
signal to the receiver an identifier of the base model, in response to the presence of the weight update between the second epoch of training and the first epoch of training.

7. The apparatus of claim 6,
wherein the signaling of the presence or absence of the weight update between the second epoch of training and the first epoch of training is part of a model parameter set syntax; and
wherein the signaling of the identifier of the base model is part of the model parameter set syntax.

8. The apparatus of claim 1, wherein the instructions, when executed by the at least one processor, cause the apparatus at least to:
signal a one-bit flag indicating a presence of both the weight update between the second epoch of training and the first epoch of training, and information related to the base model.

9. The apparatus of claim 1, wherein the instructions, when executed by the at least one processor, cause the apparatus at least to:
signal to a receiver with a one-bit indication whether a parameter update tree is used to reference parameters of the base model.

10. The apparatus of claim 1, wherein the instructions, when executed by the at least one processor, cause the apparatus at least to:
signal to a receiver with a one-bit indication a presence or absence of the weight update between the second epoch of training and the first epoch of training;
signal to the receiver with a one-bit indication whether a parameter update tree is used to reference parameters of the base model; and
signal information that an identifier of a base model is present, in response to the presence of the weight update between the second epoch of training and the first epoch of training, and the parameter update tree not being used to reference parameters of the base model.

11. An apparatus comprising:
at least one processor; and
at least one memory storing instructions that, when executed by the at least one processor, cause the apparatus at least to:
determine whether to communicate a weight update to at least one weight of a neural network between a second epoch of training the neural network and a first epoch of training the neural network;
wherein the determination of whether to communicate the weight update between the second epoch of training and the first epoch of training is made at a model level independent of a tensor content or a validation scheme; and
signal to a receiver with a one-bit indication a presence or absence of the weight update between the second epoch of training and the first epoch of training.

12. The apparatus of claim 11, wherein the instructions, when executed by the at least one processor, cause the apparatus at least to:
signal to the receiver an identifier of a base model used to determine whether to communicate the weight update.

13. The apparatus of claim 12,
wherein the signaling of the presence or absence of the weight update between the second epoch of training and the first epoch of training is part of a model parameter set syntax; and
wherein the signaling of the identifier of the base model is part of the model parameter set syntax.

14. The apparatus of claim 11, wherein the instructions, when executed by the at least one processor, cause the apparatus at least to:
signal to the receiver a one-bit flag indicating a presence of both the weight update between the second epoch of training and the first epoch of training, and information related to the base model.

15. The apparatus of claim 11, wherein the instructions, when executed by the at least one processor, cause the apparatus at least to:
signal to the receiver with a one-bit indication whether a parameter update tree is used to reference parameters of the base model.

16. The apparatus of claim 11, wherein the instructions, when executed by the at least one processor, cause the apparatus at least to:
signal information that an identifier of the base model is present, in response to the presence of the weight update between the second epoch of training and the first epoch of training, and a parameter update tree not being used to reference parameters of the base model;
wherein the presence or absence of the weight update between the second epoch of training and the first epoch of training is signaled to the receiver with a one-bit indication;
wherein whether the parameter update tree is used to reference parameters of the base model is signaled with a one-bit indication.

17. An apparatus comprising:
at least one processor; and
at least one memory storing instructions that, when executed by the at least one processor, cause the apparatus at least to:
receive signaling of a presence or absence of a weight update between a second epoch of training a neural network and a first epoch of training the neural network;
wherein the signaling of the presence or absence of the weight update between the second epoch of training and the first epoch of training is received independent of a tensor content or a validation scheme;
decode an identifier of a base model used to train the neural network, in response to the presence of the weight update between a second epoch of training a neural network and a first epoch of training the neural network; and
decode a payload of a neural network data unit with applying the weight update to the base model, in response to decoding the identifier of the base model used to train the neural network.

18. The apparatus of claim 17, wherein the instructions, when executed by the at least one processor, cause the apparatus at least to:
decode a one-bit indication whether a parameter update tree is used to reference parameters of the base model.

19. The apparatus of claim 17, wherein the instructions, when executed by the at least one processor, cause the apparatus at least to:
decode a one-bit indication of the presence or absence of the weight update between the second epoch of training and the first epoch of training;
decode a one-bit indication of whether a parameter update tree is used to reference parameters of the base model; and
decode the identifier of the base model, in response to decoding the presence of the weight update between the second epoch of training and the first epoch of training, and decoding the parameter update tree not being used to reference parameters of the base model.

20. The apparatus of claim 17,
wherein the signaling of the presence or absence of the weight update between the second epoch of training and the first epoch of training part of a model parameter set syntax; and
wherein the signaling of the identifier of the base model is part of the model parameter set syntax.

21.-29. (canceled)

30. The apparatus of claim 1, wherein the instructions, when executed by the at least one processor, cause the apparatus at least to:
receive an identifier of the base model from a server.

31. The apparatus of claim 30, wherein the identifier of the base model is received from the server when the base model is first communicated to the apparatus, in the form of a value of a high-level syntax element.

32. The apparatus of claim 1, wherein the instructions, when executed by the at least one processor, cause the apparatus at least to:
create an identifier of the base model; and
update the identifier of the base model at a communication round.

33. The apparatus of claim 32, wherein the identifier of the base model is a number that is incremented by one at each communication round.

34. The apparatus of claim 11, wherein the instructions, when executed by the at least one processor, cause the apparatus at least to:
receive an identifier of a base model from a server, the base model used at least partially to determine whether to communicate the weight update.

35. The apparatus of claim 34, wherein the identifier of the base model is received from the server when the base model is first communicated to the apparatus, in the form of a value of a high-level syntax element.

36. The apparatus of claim 11, wherein the instructions, when executed by the at least one processor, cause the apparatus at least to:
create an identifier of a base model, the base model used at least partially to determine whether to communicate the weight update; and
update the identifier of the base model at a communication round.

37. The apparatus of claim 36, wherein the identifier of the base model is a number that is incremented by one at each communication round.

38. The apparatus of claim 17, wherein the instructions, when executed by the at least one processor, cause the apparatus at least to:
receive an identifier of the base model from a server.

39. The apparatus of claim 38, wherein the identifier of the base model is received from the server when the base model is first communicated to the apparatus, in the form of a value of a high-level syntax element.

40. The apparatus of claim 17, wherein the instructions, when executed by the at least one processor, cause the apparatus at least to:
create an identifier of the base model; and
update the identifier of the base model at a communication round.

41. The apparatus of claim 40, wherein the identifier of the base model is a number that is incremented by one at each communication round.
